(19) United States
(12) Patent Application Publication
(10) Pub. No.: US 2016/0267175 A1
(43) Pub. Date: Sep. 15, 2016

(54) ELECTRONIC APPARATUS AND METHOD OF EXTRACTING HIGHLIGHT SECTION OF SOUND SOURCE

(71) Applicant: SAMSUNG ELECTRONICS CO., LTD., Suwon-si, Gyeonggi-do (KR)

(72) Inventors: Hwa-Kyung HYUN, Gyeonggi-do (KR); Ji-Tae SONG, Gyeonggi-do (KR); Seong-Hwan KIM, Gyeonggi-do (KR); Sang-Hee PARK, Gyeonggi-do (KR)

(21) Appl. No.: 14/889,090

(22) PCT Filed: Aug. 27, 2014
(86) PCT No.: PCT/KR2014/007982

§ 371 Date: Nov. 4, 2015

(51) Int. Cl. G06F 17/30; G06F 3/0484; G10L 25/21; G06F 3/16

(52) U.S. Cl. CPC G06F 17/30743; G06F 3/162; G06F 3/165; G06F 3/04842; G10L 25/21; G06F 17/30769

(57) ABSTRACT

An electronic apparatus and a method of operating the electronic apparatus are provided. The method includes displaying, by the electronic device, a reproduction time determining mode selection screen, through which a reproduction time of at least one selected sound source file is determined; selecting a specific region included in the displayed reproduction time determining mode selection screen; and extracting a highlight section of the at least one selected sound source file in response to the selection of the specific region.

### PRIORITY

This application is a U.S. National Phase application of PCT/KR2014/007982, filed on Aug. 27, 2014 the entire content of which is incorporated herein by reference.

### BACKGROUND

1. Field of the Disclosure

The present disclosure relates generally to an electronic apparatus and a method of extracting a highlight section of a sound source.

2. Description of the Related Art

As demand for a sound source file has increased, a user has become able to store various sound source files in an electronic apparatus and reproduce a corresponding sound source file at any time and from any place, thereby improving user convenience.

However, when a user reproduces a sound source file stored in an electronic apparatus, the electronic apparatus uniformly reproduces a corresponding sound source file, with the reproduced sound starting from an introduction section, even when the user desires to reproduce the corresponding sound source file starting from a highlight section, thereby failing to satisfy needs of the user.

### SUMMARY

The present disclosure has been made to address at least the problems and disadvantages described above, and to provide at least the advantages described below. Accordingly, an aspect of the present disclosure provides an apparatus and a method of decreasing required user interaction and improving user convenience by rapidly extracting only a highlight section of a selected sound source file when a specific region included and displayed in a reproduction time determining mode is selected.

Another aspect of the present disclosure provides an apparatus and a method for rapidly extracting a section closest to a reference of a predetermined highlight pattern, which is set by analyzing a specific sound source file, as an estimated highlight section.

In accordance with an aspect of the present disclosure, there is provided a method of operating an electronic apparatus. The method includes displaying, by the electronic apparatus, a reproduction time determining mode selection screen, through which a reproduction time of at least one selected sound source file is determined; selecting a specific region included in the displayed reproduction time determining mode selection screen; and extracting a highlight section of the at least one selected sound source file in response to selection of the specific region.

In accordance with another aspect of the present disclosure, there is provided an electronic apparatus that includes a memory and a processor configured to extract a feature vector value from each divided sound source file; generate a first table and a second table with the extracted feature vector value, extract at least one estimated highlight section from a selected sound source file by using the generated second table, and extract one estimated highlight section among the extracted estimated highlight sections as a highlight section.

### BRIEF DESCRIPTION OF DRAWINGS

The above and other aspects, features, and advantages of the present disclosure will be more apparent from the following detailed description taken in conjunction with the accompanying drawings, in which:

FIGS. 1A to 1D illustrate screen configurations for setting a function registered in a setting mode by extracting a highlight section of a sound source file according to an embodiment of the present disclosure;

FIGS. 2A to 2D illustrate screen configurations for continuously reproducing only a highlight section of a sound source file according to an embodiment of the present disclosure;

FIGS. 3A to 3D illustrate screen configurations for searching for a stored sound source file by reproducing only a highlight section of a sound source file according to an embodiment of the present disclosure;

FIGS. 4A and 4B illustrate a method of extracting a feature vector value for each divided sound source file by using a multi-core solution according to an embodiment of the present disclosure;

FIGS. 5A and 5B illustrate a method of generating a first table and a second table in an electronic apparatus according to an embodiment of the present disclosure;

FIGS. 6A to 6C illustrate a method of extracting an estimated highlight section by attempting to perform first to third searches on the selected sound source file by the electronic apparatus according to an embodiment of the present disclosure;

FIG. 7 illustrates a method of extracting an estimated highlight section of a sound source file by the electronic apparatus according to an embodiment of the present disclosure;

FIG. 8 is a flowchart of a method of extracting a highlight section of a sound source file by the electronic apparatus according to an embodiment of the present disclosure;

FIG. 9A is a flowchart of a method of extracting a highlight section of a sound source file by the electronic apparatus according to an embodiment of the present disclosure;

FIG. 9B is a flowchart describing a method of operation of the electronic apparatus for extracting a highlight section of a sound source according to an embodiment of the present disclosure; and

FIG. 10 is a block diagram illustrating the electronic apparatus according to an embodiment of the present disclosure.

### DETAILED DESCRIPTION

Hereinafter, embodiments of the present disclosure will be described in detail with reference to the accompanying drawings. Further, in the following description of the present disclosure, a detailed description of known functions and configurations incorporated herein is omitted to avoid obscuring the subject matter of the present disclosure. Meanwhile, terms described later are to be considered based on the functions of the present disclosure, and the meaning of the terms may be changed according to a user, intention of an operator, or convention. Accordingly, the meaning of the terms should be made on the basis of the overall context of the embodiments, as set forth below.

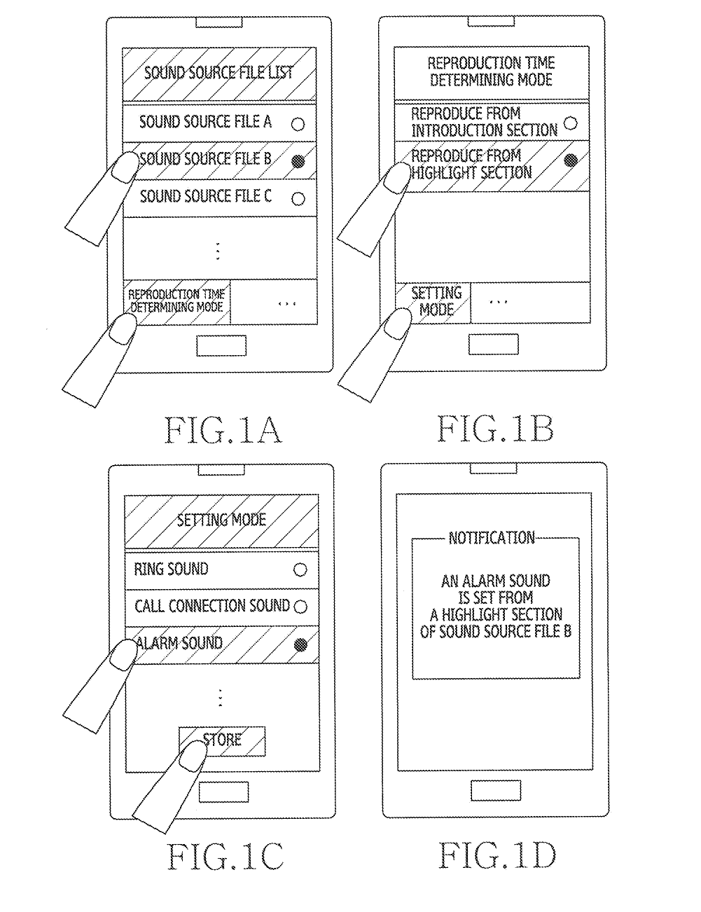

FIGS. 1A, 1B, 1C, and 1D illustrate screen configurations for setting a function registered in a setting mode by extracting a highlight section of a sound source file according to an embodiment of the present disclosure. As illustrated in FIG. 1A, the electronic apparatus displays a sound source file list that displays at least one sound source file list stored in the electronic apparatus.

For example, the electronic apparatus receives a selection of any one sound source file among a plurality of sound source files registered in the displayed sound source file list. For example, the electronic apparatus receives a selection of “sound source file B” among a plurality of sound source files registered in the sound source file list.

The electronic apparatus receives a selection of a reproduction time determining mode among one or more modes displayed on a touch screen. Here, the reproduction time determining mode is a mode in which a reproduction time of the selected sound source file is determined. More particularly, the reproduction time determining mode is a mode in which a determination is made of whether to reproduce the selected sound source file from an introduction section or a highlight section.

When an electronic apparatus in the related art receives an input of a command for reproducing a selected sound source file, the electronic apparatus uniformly reproduces the selected sound source file from an introduction section. However, an electronic apparatus according to the present disclosure includes the reproduction time determining mode and reproduces a selected sound source file from a highlight section according to a selection of a user, thereby satisfying various demands of the user.

As illustrated in FIG. 1B, the electronic apparatus receiving the selection of the reproduction time determining mode displays a reproduction time determining mode selection screen, through which a reproduction time may be determined, on the touch screen of the electronic apparatus. More particularly, the electronic apparatus may display a reproduction from introduction section region, in which the selected sound source is reproduced from an introduction section, and a reproduction from highlight section region, in which the selected sound source is reproduced from a highlight section on the touch screen of the electronic apparatus.

The electronic apparatus receives a selection of any one region among the two regions included in and displayed on the reproduction time determining mode selection screen. When the electronic apparatus receives a selection of the reproduction from introduction section region displayed on the reproduction time determining mode selection screen, the electronic apparatus reproduces the selected sound source file from an introduction section. However, when the electronic apparatus receives a selection of the reproduction from highlight section region displayed on the reproduction time determining mode selection screen, the electronic apparatus extracts a highlight section of the selected sound source file, and reproduces the selected sound source file from a highlight section.

When the electronic apparatus receives the selection of the reproduction from highlight section region displayed on the reproduction time determining mode selection screen as illustrated in FIG. 1B, the electronic apparatus receives a selection of a setting mode among one or more modes displayed on the touch screen thereof.

As illustrated in FIG. 1C, the electronic apparatus displays a plurality of functions, i.e., setting modes, registered in a setting mode selection screen on the touch screen thereof. For example, the electronic apparatus may display the plurality of functions, i.e., setting modes, such as a ring sound, a call connection sound, and an alarm sound, registered in the setting mode selection screen on the touch screen thereof.

The electronic apparatus receives a selection of at least one function among the functions registered in the setting mode selection screen, and then stores the selected function. For example, as illustrated in FIG. 1C, the electronic apparatus receives a selection of an alarm sound function among the functions registered in the setting mode selection screen, receives a command to store the selected alarm sound function, and stores the alarm sound function.

Then, as illustrated in FIG. 1D, the electronic apparatus displays a notification message “an alarm sound is set from a highlight section of sound source file B” on the touch screen thereof.

As described above, the electronic apparatus according to the present disclosure include the reproduction time determining mode, i.e., selection screen, and rapidly extracts only a highlight section of a selected sound source file when a specific region included in the displayed reproduction time determining mode selection screen is selected, thereby decreasing required user interaction and improving user convenience.

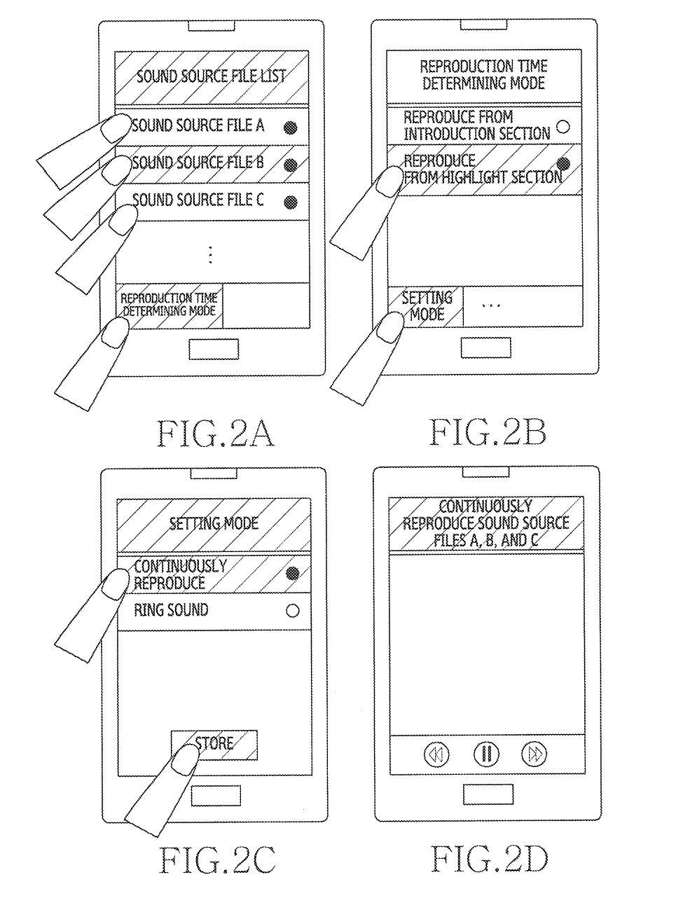

FIGS. 2A to 2D illustrate screen configurations for continuously reproducing only a highlight section of a sound source file according to an embodiment of the present disclosure. As illustrated in FIG. 2A, the electronic apparatus displays a sound source file list, and displays at least one sound source file list stored in the electronic apparatus.

The electronic apparatus receives a selection of two or more sound source files among a plurality of sound source files registered in the sound source file list. For example, as illustrated in FIG. 2A, the electronic apparatus may receive a selection of “sound source file A”, “sound source file B”, and “sound source file C”.

As illustrated in FIGS. 2A and 2B, the electronic apparatus receives a selection of the reproduction time determining mode among one or more modes displayed on the touch screen of the electronic apparatus, and displays the reproduction time determining mode selection screen, through which a reproduction time is determined, on the touch screen thereof.

When the electronic apparatus receives a selection of a reproduce from highlight section region, between among the regions of the reproduction time determining mode selection screen displayed on the touch screen, and receives a selection of a setting mode region, as illustrated in FIG. 2B, the electronic apparatus displays the setting mode selection screen on the touch screen thereof.

As illustrated in FIG. 2C, the electronic apparatus displays a plurality of functions, i.e., modes, registered in the setting mode selection screen on the touch screen thereof. For example, the electronic apparatus may display functions, such as continuous reproduction and a ring sound, registered in the setting mode selection screen on the touch screen thereof.

The electronic apparatus, which displays the function registered in the setting mode screen on the touch screen, receives a selection of at least one function among the functions registered in the setting mode screen of the electronic apparatus, and stores the selected function. For example, as illustrated in FIG. 2C, the electronic apparatus receives a selection of a continuous reproduction function among the functions registered in the setting mode selection screen, receives a command to store the selected continuous reproduction function, and stores the continuous reproduction function.

Then, as illustrated in FIG. 2D, the electronic apparatus continuously reproduces only highlight sections of the selected “sound source file A”, “sound source file B”, and “sound source file C”. That is, the electronic apparatus extracts only highlight sections of two or more selected sound source files, and continuously reproduces the highlight sections.

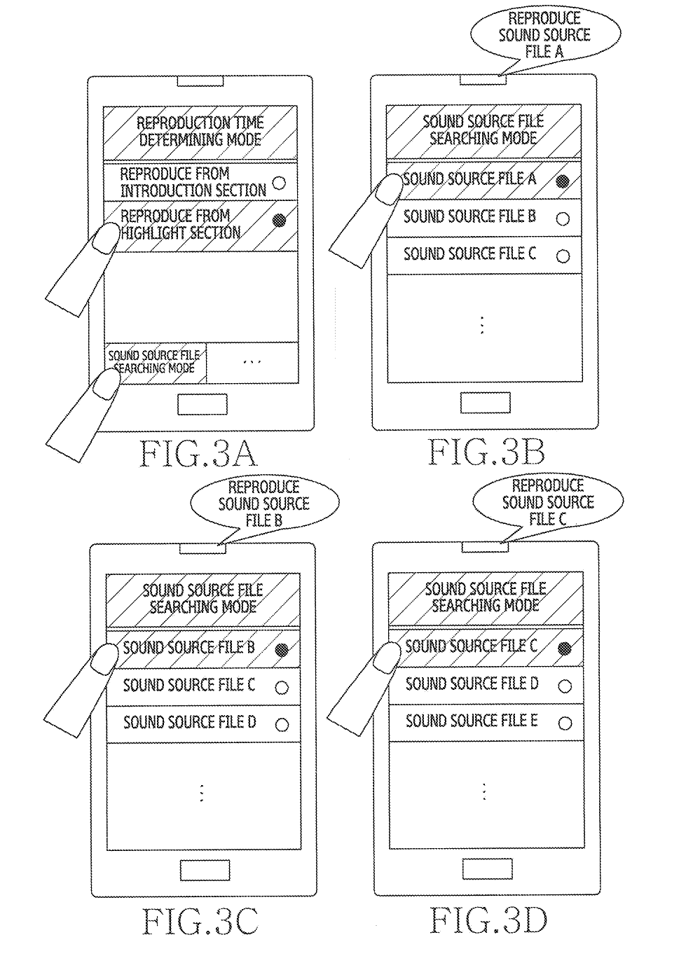

FIGS. 3A to 3D illustrate screen configurations for searching for a stored sound source file by reproducing only a highlight section of a sound source file according to an embodiment of the present disclosure. As illustrated in FIG. 3A, the electronic apparatus receives a selection of the reproduction time determining mode and displays the reproduction time determining mode selection screen, through which a reproduction time is determined, on the touch screen of the electronic apparatus.

When the electronic apparatus receives a selection of the reproduce from highlight section region from among the regions displayed on the reproduction time determining mode selection screen, as illustrated in FIG. 3A, and the electronic apparatus enters a selection of a sound source file searching mode and displays a sound source file searching mode selection screen on the touch screen thereof.

Here, the sound source file searching mode is a mode through which a user searches for a sound source file by reproducing a plurality of sound source files stored in the electronic apparatus from an introduction section or a highlight section.

When the electronic apparatus receives a selection of any one sound source file among the plurality of sound source files displayed on the sound source file searching mode selection screen, the electronic apparatus reproduces the selected sound source file.

For example, when the electronic apparatus receives a selection of sound source file A among the plurality of sound source files displayed on the sound source file searching mode selection screen as illustrated in FIG. 3B, the electronic apparatus reproduces only an extracted highlight section of the selected sound source file A. Since the electronic apparatus previously received the reproduce from highlight section command, the electronic apparatus reproduces only the extracted highlight section of the selected sound source file A.

Similarly, when the electronic apparatus receives a selection of sound source file B and sound source file C among the plurality of sound source files displayed on the sound source file searching mode selection screen, as illustrated in FIGS. 3C and 3D, the electronic apparatus reproduces only highlight sections of the selected sound source file B and sound source file C.

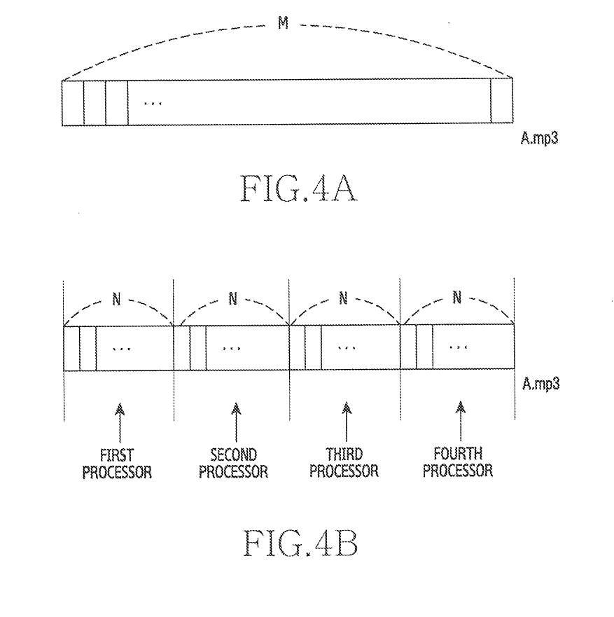

FIGS. 4A and 4B illustrate a method of extracting a feature vector value for each divided sound source file by using a multi-core solution according to an embodiment of the present disclosure. As illustrated in FIG. 4A, when the electronic apparatus receives an input of a command to extract only a highlight section of at least one sound source file, the electronic apparatus divides the selected sound source file into a predetermined number of files.

For example, when the electronic apparatus receives a command to extract only a highlight section of sound source file A among a plurality of sound source files stored in the electronic apparatus, when a number for dividing the selected sound source file is set to M, and when a total of four processors, i.e., first to fourth processors, are provided, the electronic apparatus divides the selected sound source file A into M files.

As illustrated in FIG. 4B, the electronic apparatus perform a multi-core solution, in which each processor provided in the electronic apparatus is assigned with the same number of divided files to extract a feature vector value.

That is, for a total of four processors, the electronic apparatus performs the multi-core solution in which each processor is assigned with the same number, e.g., N, of divided files among the M divided files, and extracts a feature vector value. Accordingly, when performing the multi-core solution, the electronic apparatus extracts a highlight section at a faster speed compared to a conventional electronic apparatus.

Here, the feature vector value is a power value of an audio signal, and is determined according to Equation (1)

$$power = 20 log \frac{Σ {x}^{2}}{N} \qquad ( 1 )$$

In Equation (1), x represents amplitude of a sample value, and N represents a number of sample values for a predetermined time.

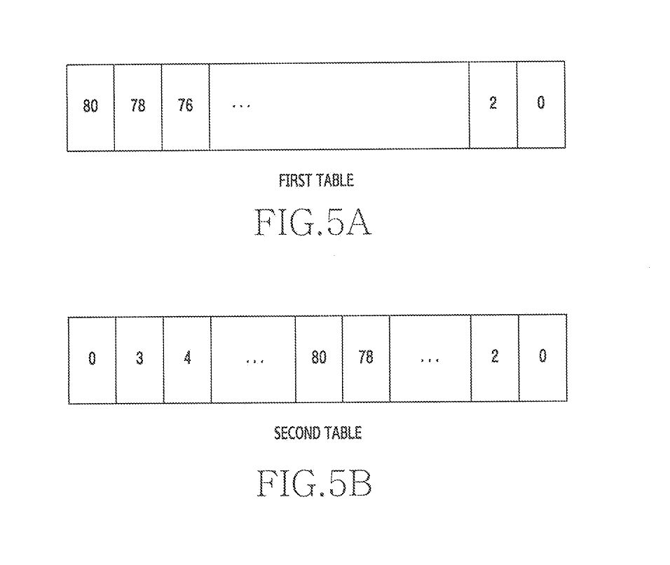

In the present embodiment, it is assumed that the four processors are provided in the electronic apparatus, but the electronic apparatus may perform the multi-core solution according to the number of processors provided in the electronic apparatus FIGS. 5A and 5B illustrate a method of generating a first table and a second table in an electronic apparatus according to an embodiment of the present disclosure.

As illustrated in FIG. 5A, the electronic apparatus generates a first table using the extracted feature vector value. In the first table, the extracted feature vector values are classified in a size order.

For example, as illustrated in FIG. 5A, the feature vector values are extracted from the electronic apparatus in a size order of 80, 78, 76, . . . , and the electronic apparatus generates the first table in which the extracted feature vector values are classified in the size order, 80, 78, 76, . . . , of the extracted feature vector values from a left space.

The electronic apparatus generating the first table generates a second table using the generated first table. In the second table, the extracted feature vector values are classified in a time order.

For example, as illustrated in FIG. 5B, a size of a feature vector value extracted at time t1 by the electronic apparatus is 0, a size of a feature vector value extracted at time t2 by the electronic apparatus is 3, a size of a feature vector value extracted at time t3 by the electronic apparatus is 4, a size of a feature vector value extracted at time tx by the electronic apparatus is 80, a size of a feature vector value extracted at time ty by the electronic apparatus is 78, and the like.

Accordingly, the electronic apparatus generates a second table in which the feature vector values corresponding to the respective times are classified in a time order of t1, t2, t3, tx, ty, and the like. Then, the electronic apparatus extracts at least one estimated highlight section within the selected sound source file using the generated second table.

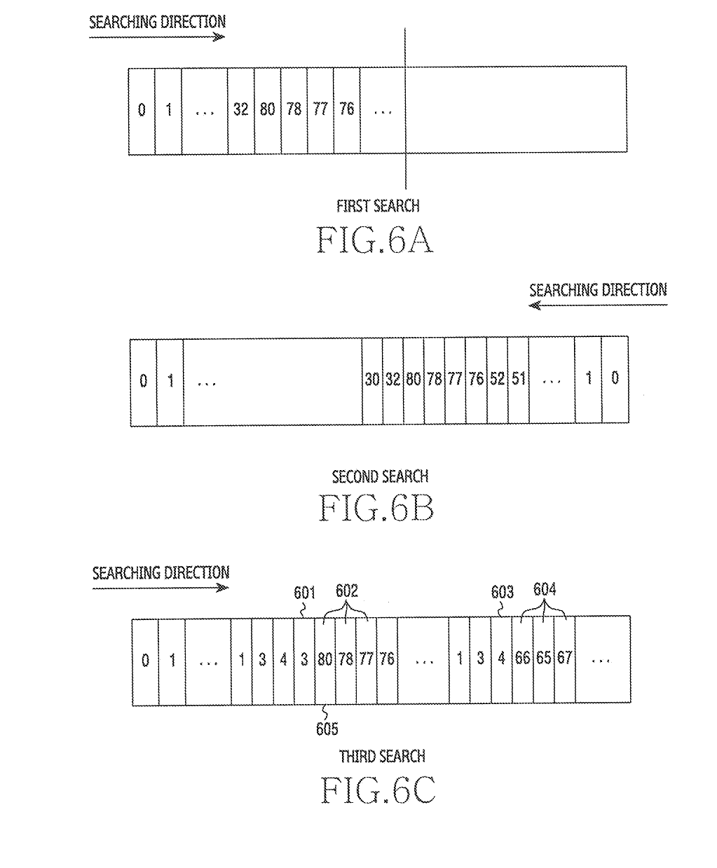

FIGS. 6A to 6C illustrate a method of extracting an estimated highlight section by attempting to perform first to third searches on the selected sound source file by the electronic apparatus according to an embodiment of the present disclosure.

As illustrated in FIG. 6A, the electronic apparatus performs a first search to determine whether a difference in a feature vector value with predetermined previous sections within the divided sound source file section is greater than or equal to a predetermined value, and to determine whether the predetermined feature vector value is maintained on the sound source file, which is selected to extract a highlight section.

For example, if the sound source file section divided by the electronic apparatus is half of the sound source file, the number of predetermined previous sections is five, a predetermined value of a difference in a feature vector value with the predetermined previous sections is forty-five, the predetermined number of sections of a feature vector value, in which it is determined whether the feature vector value is maintained, is four, and a range of the predetermined feature vector value is five.

Accordingly, the electronic apparatus searches only a half section of the generated second table for the sound source file selected to extract a highlight section to determine whether an estimated highlight section exists. That is, the electronic apparatus begins to search based on the first feature vector value at a left side, and determines whether a difference in a feature vector value of five predetermined previous sections is greater than or equal to forty-five, and whether the feature vector value is maintained within five, which is a range of the predetermined feature vector value within four sections that is a range of the predetermined feature vector values.

As illustrated in FIG. 6A, the electronic apparatus confirms that the aforementioned condition is not satisfied before the section selecting a feature vector value “80”, and selects 80 as a feature vector value that is a reference of the first search. Then, the electronic apparatus confirms that a difference in the feature vector value of the previous five sections is greater than or equal to 45 based on the feature vector value “80”, and the feature vector value within five in four sections after the feature vector value “80” is maintained. Accordingly, the electronic apparatus registers the section having the feature vector value “80” as an estimated highlight section.

The electronic apparatus of the present disclosure searches only a predetermined section of the second table generated for the sound source file, which is selected to extract a highlight section, regarding whether an estimated highlight section exists, thereby more rapidly estimating a highlight section. Most of the sound source files have highlight sections before a half section of the sound source file, so that even though the entire sound source file is not searched, a highlight section is estimated by rapidly searching only the half section of the sound source file.

In the present embodiment, the search begins from a left side, but is not limited thereto, and may begin at a right side of a half section of the sound source file.

When the electronic apparatus performs the first search, but determines that the estimated highlight section is not discovered, the electronic apparatus performs a second search of changing a searching section of the selected sound source file to the entire sound source file.

As illustrated in FIG. 6B, the electronic apparatus equally performs the first search from a back part of the sound source file, which is selected to extract an estimated highlight section. That is, the electronic apparatus attempts to perform the first search capable of more rapidly extracting the estimated highlight section. When it is determined that the estimated highlight section is not discovered, the electronic apparatus performs the second, more detailed, search capable of searching for the estimated highlight section.

When the electronic apparatus performs the second search, but determines that the estimated highlight section is not discovered, the electronic apparatus performs a third search that again changes a searching section of the selected sound source file. More particularly, the electronic apparatus changes the searching method to a searching method that searches for a section belonging to a predetermined subordinate feature vector value or less than the predetermined subordinate feature vector value in the selected sound source file, compares the feature vector value of the searched section with the predetermined number of subsequent feature vector values, and confirms whether the largest difference in the feature vector value is drawn. Hereinafter, the method will be described in more detail based on an example of the second table illustrated in FIG. 6C.

For example, if the electronic apparatus sets a predetermined subordinate feature vector value to three, and the number of predetermined feature vector values compared with the feature vector value is three, the electronic apparatus searches for a feature vector value less than or equal to four, which is the predetermined subordinate feature vector value based on the feature vector value from a left section of the second table.

As shown in FIG. 6C, the electronic apparatus may search for the feature vector value less than or equal to three, which is the predetermined subordinate feature vector value from the left section, and compare the discovered feature vector value 601 of “3” with the three predetermined feature vector values 602 to calculate a difference in a feature vector value. More particularly, the electronic apparatus calculates the feature vector value as 75.33, which is a difference between the average feature vector value of 78.33 of the three predetermined feature vector values 602 and the feature vector value of three.

Then, as a result continuously performing the third search, the electronic apparatus compares the discovered feature vector value 603 of “4” with the three predetermined feature vector values 604 to calculate a difference in a feature vector value. More particularly, the electronic apparatus calculates the feature vector value of 62, which is a difference between the average feature vector value of 66 of the three predetermined feature vector values 604 and the feature vector value of four.

Finally, the electronic apparatus confirms 75.33, which is the largest difference in the feature vector value between the previously calculated feature vector values 75.33 and 62, and extracts a section corresponding to a feature vector value 605 of 80 as the estimated highlight section.

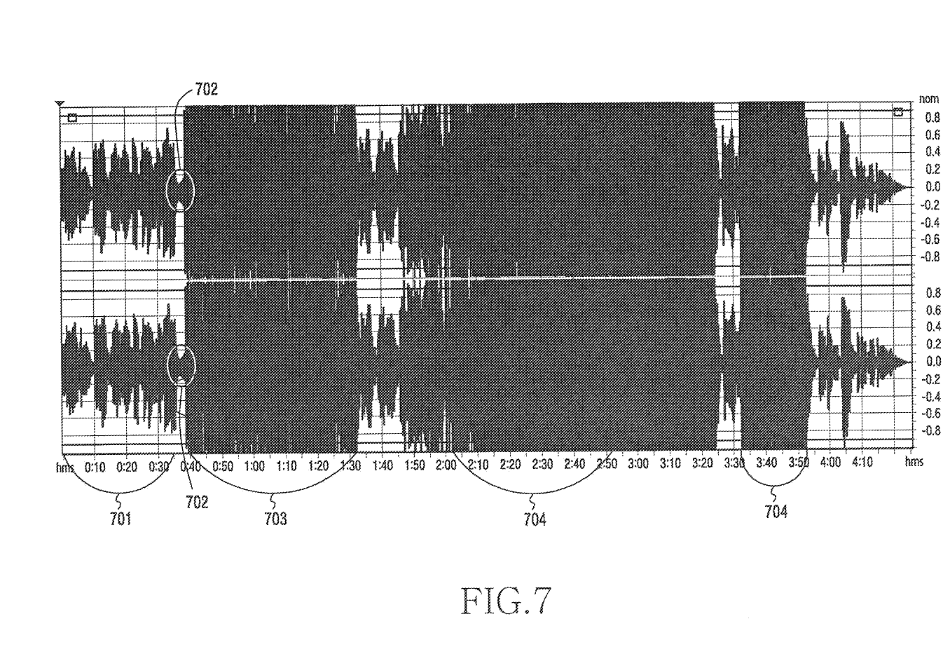

FIG. 7 illustrates a method of extracting an estimated highlight section of a sound source file by the electronic apparatus according to an embodiment of the present disclosure. As illustrated in FIG. 7, based on a reference for extracting an estimated highlight section, a feature vector value before a highlight section is maintained with a value less than or equal to a predetermined feature vector value shown at reference 701 in FIG. 7.

Further, based on a reference for extracting an estimated highlight section, when the highlight section starts, the feature vector value is suddenly increased to the predetermined feature vector value or more, as shown at reference 702 in FIG. 7.

Further, based on a reference for extracting an estimated highlight section, the feature vector value is maintained within a range of the predetermined feature vector value at a highlight section shown at reference 703 in FIG. 7.

Further, based on a reference for extracting an estimated highlight section, the highlight section generally appears just before an end of the first verse and the second verse in the entire corresponding sound source file, as shown at references 704 in FIG. 7.

According to various embodiments, the electronic apparatus extracts an estimated highlight section with reference to the aforementioned characteristics 701 to 704, but is not limited to the aforementioned embodiment.

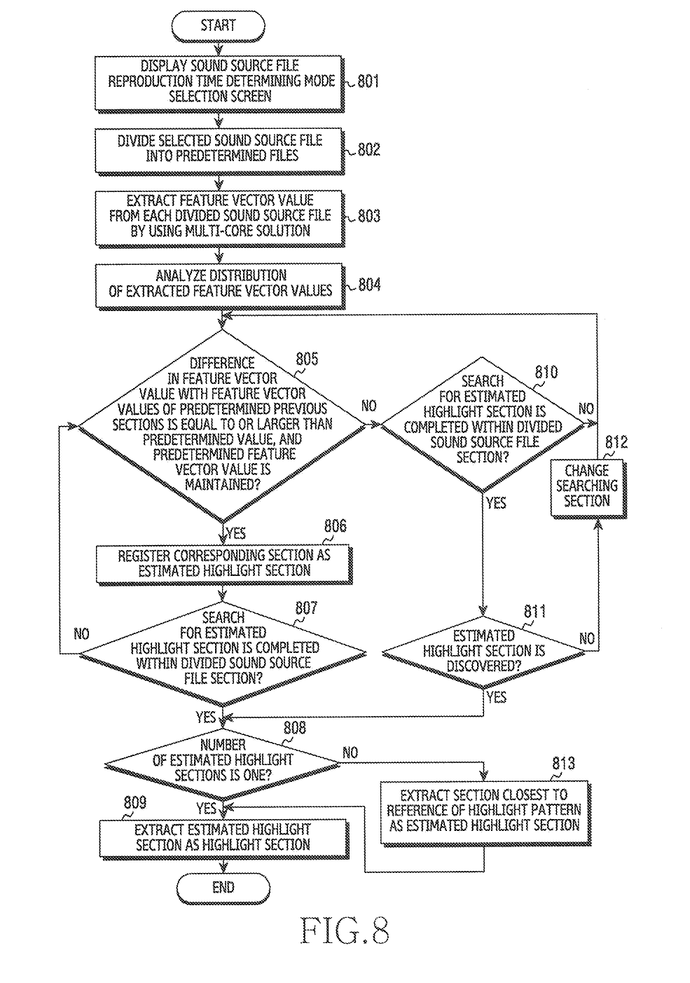

FIG. 8 is a flowchart of a method of extracting a highlight section by the electronic apparatus according to an embodiment of the present disclosure. As illustrated in FIG. 8, in step 801, the electronic apparatus displays a reproduction time determining mode screen, through which a reproduction time of a selected sound source file is determined, on the touch screen thereof. More particularly, the electronic apparatus displays at least one sound source file list stored therein, receives a selection of a reproduction time determining mode among one or more modes displayed on the touch screen thereof, and displays a reproduction time determining mode selection screen on the touch screen thereof. In step 802, the electronic apparatus divides the selected sound source file into the predetermined number of files. Here, the electronic apparatus divides the selected sound source file into the predetermined number of files in order to perform a multi-core solution, in which each processor is assigned with the same number of divided files among the divided files, and extracts a feature vector value.

In step 803, the electronic apparatus extracts a feature vector value from each divided sound source file using the multi-core solution. In step 804, the electronic apparatus analyzes a distribution of the extracted feature vector values. For example, the electronic apparatus generates a first table, in which the extracted feature vector values are classified in a size order, and generates a second table, in which the extracted feature vector values are classified in a time order, by using the generated first table. Here, the generated second table is used for extracting an estimated highlight section for the selected sound source file.

In step 805, the electronic apparatus may determine whether a difference in a feature vector value with predetermined previous sections is greater than or equal to a predetermined value, and a predetermined feature vector value is maintained. More particularly, the electronic apparatus performs a first search of determining whether a difference in a feature vector value with predetermined previous sections within the divided sound source file section is greater than or equal to a predetermined value, and determining whether the predetermined feature vector value is maintained on the sound source file, which is selected to extract a highlight section. For example, if the sound source file section divided by the electronic apparatus is a half of the sound source file, the number of predetermined previous sections is three, a predetermined value of a difference in a feature vector value with the predetermined previous sections is 70, the predetermined number of sections of a feature vector value, in which it is determined whether the feature vector value is maintained, is six, and a range of a predetermined feature vector value is four. Based on the above, the electronic apparatus searches only a half section of the generated second table for the sound source file selected to extract a highlight section regarding whether an estimated highlight section exists. That is, the electronic apparatus begins searching based on the first feature vector value at a left side, and determines whether a difference in a feature vector value with three predetermined previous sections is greater than or equal to 70, and whether the feature vector value is maintained within four, which is a range of the predetermined feature vector value within six sections that is a range of the predetermined feature vector values.

When the electronic apparatus determines that the difference in a feature vector value with the predetermined previous sections is greater than or equal to a predetermined value, and the predetermined feature vector value is maintained in the step 805, the electronic apparatus registers a corresponding section as an estimated highlight section in step 806. For example, as a result of the performance of the first search with reference to the second table, when the electronic apparatus determines that the section having a feature vector value of “80” satisfies the aforementioned condition, the electronic apparatus registers a section having the feature vector value of “80” as an estimated highlight section.

In step 807, the electronic apparatus determines whether the search for the estimated highlight section in the divided sound source file sections is completed. More particularly, the electronic apparatus determines whether the first search of determining whether the difference in a feature vector value with the predetermined previous sections within the predetermined section is greater than or equal to the predetermined value and the predetermined feature vector value is maintained is completed.

When the electronic apparatus determines that the search for the estimated highlight section in the divided sound source file section is completed in step 807, the electronic apparatus determines whether the number of registered estimated highlight sections is one in step 808. More particularly, the electronic apparatus determines whether the number of registered estimated highlight sections within the divided sound source file section is one because the highlight section is the same in one sound source file, and thus it is not necessary to perform another search.

When the electronic apparatus determines that the number of registered estimated highlight sections is one in step 808, the electronic apparatus extracts the estimated highlight section as a highlight section in step 809. The reason is that the highlight section is the same in one sound source file, and thus it is not necessary to perform another search.

When the electronic apparatus determines that the difference in the feature vector value with the predetermined previous sections is not greater than or equal to the predetermined value, and the predetermined feature vector value is not maintained in step 805, the electronic apparatus determines whether the search for the estimated highlight section in the divided sound source file is completed in step 810. More particularly, the electronic apparatus determines whether the first search of determining whether the difference in the feature vector value with the predetermined previous sections within the predetermined section is greater than or equal to the predetermined value, and the predetermined feature vector value is maintained.

The electronic apparatus determines whether the estimated highlight section is discovered in step 811. More particularly, the electronic apparatus determines whether the estimated highlight section is discovered as a result of the completion of the first search of determining whether the difference in the feature vector value with the predetermined previous sections within the predetermined section is greater than or equal to the predetermined value, and the predetermined feature vector value is maintained.

When the electronic apparatus determines that the estimated highlight section is not discovered in step 811, the electronic apparatus changes the searching section in step 812. More particularly, when the electronic apparatus performs the first search, but determines that the estimated highlight section is not discovered, the electronic apparatus performs a second search, changing a searching section of the selected sound source file to the entire sound source file. Further, when the electronic apparatus performs the second search, but determines that the estimated highlight section is not discovered, the electronic apparatus performs a third search of changing a searching section of the selected sound source file again. More particularly, the electronic apparatus changes the method to a searching method of searching for a section belonging to the predetermined subordinate feature vector value or less than the predetermined subordinate feature vector value in the selected sound source file, compares the feature vector value of the searched section with the predetermined number of subsequent feature vector values, and confirms whether the largest difference in the feature vector value is drawn. That is, when the electronic apparatus first performs step 811, the electronic apparatus may perform the second search by changing the searching section, and when the electronic apparatus secondarily performs step 811, the electronic apparatus may perform the third search by changing the searching section.

When the electronic apparatus determines that the estimated highlight section is discovered in step 811, the electronic apparatus proceeds to step 808 of determining whether the number of registered estimated highlight sections is one.

When the electronic apparatus determines that the number of registered estimated highlight sections is at least two in step 808, the electronic apparatus extracts a section closest to a reference of a highlight pattern as the estimated highlight section in step 813. References of the highlight pattern are based on the following. A first reference of the highlight pattern is based on an average feature vector value for a predetermined time before the estimated highlight section being smaller than an average vector value for a subsequent predetermined time. A second reference of the highlight pattern is based on an average feature vector value of a highlight section having a value greater than or equal to a reference feature vector value. A third reference of the highlight pattern is based on a section, in which a feature vector value is decreased within the section after the predetermined time from a start feature vector value of the estimated highlight section registered as the estimated highlight section, needs to be excluded from the estimated highlight section. A fourth reference of the highlight pattern is based on, when an average feature vector value for a predetermined time before the estimated highlight section is close to a reference feature vector value, a high probability exists in that the section is a start time point of the highlight section. A fifth reference of the highlight pattern is based on, when a feature vector value after a predetermined time from a start time point of the estimated highlight section is sharply decreased to a predetermined value or less than the predetermined value compared to a feature vector value at the start time point of the estimated highlight section, the section is excluded from the estimated highlight section. A sixth reference of the highlight pattern is based on when a difference between an average feature vector value for a predetermined time after the start time point of the estimated highlight section and an average feature vector value for a predetermined time before the start time point of the estimated highlight section is small, a high probability exists that the section is a start time point of the highlight section.

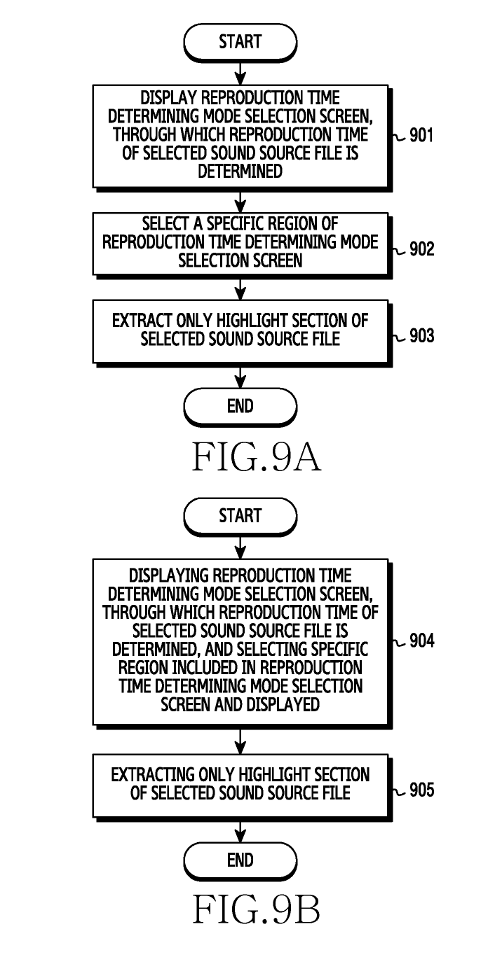

FIG. 9A is a flowchart of a method of extracting a highlight section of a sound source by the electronic apparatus according to an embodiment of the present disclosure. According to an embodiment, in step 901, the electronic apparatus displays a reproduction time determining mode screen, through which a reproduction time of a selected sound source file may be determined. More particularly, the electronic apparatus displays at least one sound source file list stored therein, receives a selection of a reproduction time determining mode among one or more modes displayed on the touch screen thereof, and displays a reproduction time determining mode selection screen on the touch screen thereof.

In step 902, the electronic apparatus selects a specific region included and displayed in the reproduction time determining mode selection screen. That is, the electronic apparatus receives a selection of a reproduction time determining mode among one or more modes displayed on the touch screen thereof. In step 903, the electronic apparatus extracts only a highlight section of the sound source file. More particularly, the electronic apparatus performs a first search of determining whether a difference in a feature vector value with predetermined previous sections is within the divided sound source file sections greater than or equal to a predetermined value, and determines whether the predetermined feature vector value is maintained on the sound source file, which is selected to extract a highlight section. Further, when the electronic apparatus performs the first search, but determines that an estimated highlight section is not discovered, the electronic apparatus performs a second search of changing a searching section of the selected sound source file to the entire sound source file. Further, when the electronic apparatus performs the second search, but determines that the estimated highlight section is not discovered, the electronic apparatus performs third search of changing a searching section of the selected sound source file again.

FIG. 9B is a flowchart describing a method of operation of the electronic apparatus for extracting a highlight section of a sound source according to an embodiment of the present disclosure. According to an embodiment, the touch screen of the electronic apparatus displays, in step 904, the reproduction time determining mode selection screen, through which a reproduction time of the selected sound source file is determined, and enables a user to select a specific region included and displayed in the reproduction time determining mode. More particularly, the touch screen of the electronic apparatus displays at least one stored sound source file list, receives a reproduction time determining mode among the one or more displayed modes and displays the reproduction time determining mode, and enables a user to select a specific region included and displayed in the reproduction time determining mode. In step 905, a processor of the electronic apparatus extracts only a highlight section of the selected sound source file. More particularly, the processor of the electronic apparatus performs a first search of determining whether a difference in a feature vector value with predetermined previous sections within the divided sound source file section is greater than or equal to a predetermined value, and determines whether the predetermined feature vector value is maintained on the sound source file, which is selected to extract a highlight section. Further, when the processor of the electronic apparatus performs the first search, but determines that an estimated highlight section is not discovered, the electronic apparatus performs a second search of changing a searching section of the selected sound source file to the entire sound source file. Further, when the processor of the electronic apparatus performs the second search, but determines that the estimated highlight section is not discovered, the electronic apparatus performs a third search of changing a searching section of the selected sound source file again.

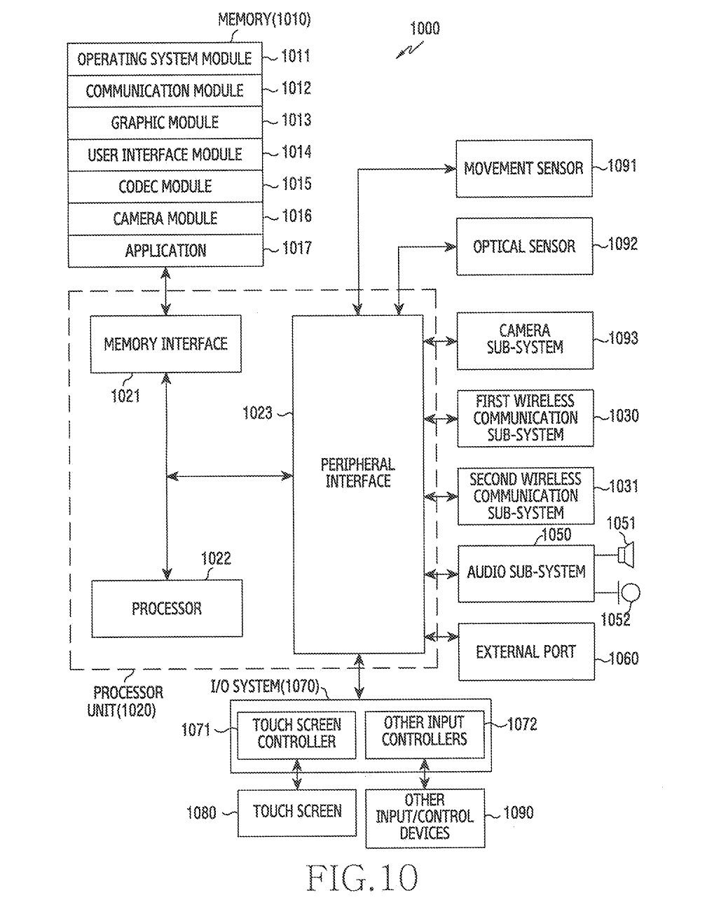

FIG. 10 is a block diagram illustrating an electronic apparatus according to the present disclosure. An electronic apparatus 1000 may be a portable electronic apparatus, and may be a device, such as a portable terminal, a mobile phone, a mobile pad, a media player, a tablet computer, a handheld computer, or a Personal Digital Assistant (PDA). Further, the electronic apparatus may be a predetermined portable electronic apparatus including a device having a combination of two or more functions among the above-enumerated devices.

The electronic apparatus 1000 includes a memory 1010, a processor unit 1020, a first wireless communication sub-system 1030, a second wireless communication sub-system 1031, an external port 1060, an audio sub-system 1050, a speaker 1051, an input/output control device 1070, a touch screen 1080, and other input or control devices 1090. Memory 1010 may be configured as a plurality of memories 1010 and external ports 1060 may be configured as a plurality of external ports.

The processor unit 1020 may include a memory interface 1021, one or more processors 1022, and a peripheral interface 1023. Depending on a case, the entire processor unit 1020 may be called a processor. In the present disclosure, the processor unit 1020 may extract only a highlight section of a selected sound source file, divide the selected sound source file into a predetermined number of files, extract a feature vector value from each sound source file by using the multi-core solution, generate a first table, in which the extracted feature vector values are classified in a size order, and a second table, in which the extracted feature vector values are classified in a time order, with the extracted feature vector values, extract at least one estimated highlight section within the selected sound source file by using the generated second table, and extract any one estimated section among the extracted estimated highlight sections as a highlight section. Further, the processor unit 1020 may compare each extracted feature vector value with the predetermined number of previous feature vector values and determine whether a difference in a feature vector value is greater than or equal to a predetermined feature vector value, compare each extracted feature vector value with a predetermined number of subsequent feature vector values and determine whether the feature vector value is maintained within a predetermined range of the feature vector value, divide the selected sound source file into a predetermined number of sections, determine whether the determination is completed within the divided section of the sound source file, and repeat the determination when it is determined that the determination is not completed within the divided section of the sound source file. Further, the processor unit 1020 determines whether the number of registered estimated highlight section is one, and when it is determined that the number of registered estimated highlight sections is one, the processor unit 1020 may extract the estimated highlight section as a highlight section. Further, when the difference in the feature vector value is greater than or equal to the predetermined feature vector value, or the feature vector value is not maintained within the predetermined range of the feature vector value, the processor unit 1020 determines whether the determination is completed within the divided section of the selected sound source file. Further, when it is confirmed that the number of registered estimated highlight sections is two or more, the processor unit 1020 extracts a section closest to a reference of a highlight pattern as the estimated highlight section. Further, the processor unit 1020 repeats the determination when it is determined that the determination is not completed, and determines whether the estimated highlight section is discovered when it is determined that the determination is completed, and changes a searching section to the entire selected sound source file and repeats the determination when it is determined that the estimated highlight section is not discovered. Further, when the processor unit 1020 changes the searching method to a searching method, in which the processor unit 1020 changes the searching section into the entire selected sound source file, and when the processor determines that the estimated highlight section is not discovered, the processor unit 1020 searches for a section belonging to a predetermined subordinate feature vector value within the selected sound source file, compares the feature vector value of the searched section with the predetermined number of subsequent feature vector values, and confirms whether a largest difference in the feature vector value is drawn.

The processor 1022 performs various functions for the electronic apparatus 1000 by executing various software programs, and also performs processing and a control for voice communication and data communication. Further, in addition to the general function, the processor 1022 may also execute a specific software module (command set) stored in the memory 1010 and perform various specific functions corresponding to the module. That is, the processor 1022 may perform the method of the embodiment of the present disclosure in connection with the software modules stored in the memory 1010.

The processor 1022 may include at least one data processor, image processor, and CODEC. The data processor, the image processor, or the CODEC may also be separately configured. Further, the data processor, the image processor, or the CODEC may also be configured by multiple processors performing different functions. The peripheral device interface 1023 connects the input/output sub-system 1070 and various peripheral devices of the electronic apparatus 1000 to the processor 1022 and the memory 1010 (through the memory interface).

Various elements of the electronic apparatus 1000 may be coupled by one or more communication buses or a stream line.

The external port 1060 is used to directly connect a portable electronic apparatus to another electronic apparatus or indirectly connect a portable electronic apparatus to another electronic apparatus through a network, e.g., the Internet, the Intranet, and a wireless Local Area Network (LAN). The external port 1060 may refer, for example, a Universal Serial Bus (USB) port or a FIREWIRE port, but is not limited thereto.

A movement sensor 1091 and an optical sensor 1092 may be coupled to the peripheral interface 1023 to enable the electronic apparatus to perform various functions. For example, the movement sensor 1091 and the optical sensor 1092 are coupled to the peripheral interface 1023 to enable the electronic apparatus to detect a movement and detect light from the outside, respectively. Moreover, other sensors, such as a positioning system, a temperature sensor, and a biometric sensor, may be connected with the peripheral interface 1023 to perform related functions.

A camera sub-system 1093 may perform a camera function, such as picture and video clip recording.

A Charged Coupled Device (CCD) or a Complementary Metal-Oxide Semiconductor (CMOS) device may be used as the optical sensor 1092.

A communication function is performed through one or more wireless communication sub-systems 1030 and 1031. The wireless communication sub-systems 1030 and 1031 may include a radio frequency receiver and transmitter, and/or an optical, e.g., infrared rays, receiver and transmitter. The first wireless communication sub-system 1030 and the second wireless communication sub-system 1031 may be divided according to a communication network through which the electronic apparatus 1000 communicates. For example, the communication network may include a communication sub-system designed to be operated through a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Fidelity (Wi-Fi) network, a WiMax network, and/or a Bluetooth network, but is not limited thereto. The first wireless communication sub-system 1030 and the second wireless communication sub-system 1031 may be combined and configured as one wireless communication sub-system.

The audio sub-system 1050 may be combined with a speaker 1051 and a microphone 1052 to input and output an audio stream, such as voice recognition, voice copy, digital recording, and a call function. That is, the audio sub-system 1050 communicates with a user through the speaker 1051 and the microphone 1052. The audio sub-system 1050 receives a data stream through the peripheral interface 1023 of the processor unit 1020, and converts the received data stream into an electric steam. The converted electric stream, i.e., electric signal, is transmitted to the speaker 1051. The speaker 1051 converts the electric stream into a sound wave audible by a person and output the sound wave. The microphone 1052 converts sound waves transmitted from a person or other sound sources into electric streams. The audio sub-system 1050 receives the electric stream converted by the microphone 1052. The audio sub-system 1050 converts the received electric stream into an audio data stream, and transmits the converted audio data stream to the peripheral interface 1023. The audio sub-system 1050 may include an attachable and detachable ear phone, head phone, or head set.

The input/output (I/O) sub-system 1070 may include a touch screen controller 1071 and/or other input controllers 1072. The touch screen controller 1071 may be combined with the touch screen 1080. The touch screen 1080 and the touch screen controller 1071 may detect, without being limited thereto, a contact, a movement, or an interruption thereof, using not only capacitive, resistive, infrared ray, and surface sound wave technologies for determining one or more contact points with the touch screen 1080 but also certain multi-touch detection technologies including other proximity sensor arrays or other elements. Other input controllers 1072 may be combined with other input/control devices 1090. Other input/control devices 1090 may be pointer devices, such as one or more buttons, a rocker switch, a thumb wheel, a dial, a stick, and/or a stylus.

The touch screen 1080 provides an I/O interface between the electronic apparatus 1000 and the user. That is, the touch screen 1080 transfers a touch input of a user to the electronic apparatus 1000. Further, the touch screen 1080 displays an output from the electronic apparatus 1000 to the user. That is, the touch screen 1080 displays a visual output to the user. The visual output is represented in a form of text, graphic, video, and a combination thereof.

The touch screen 1080 may employ various displays. For example, the touch screen 1080 may employ a Liquid Crystal Display (LCD), a Light Emitting Diode (LED), a Light Emitting Polymer (LPD) display, an Organic Light Emitting Diode (OLED), an Active Matrix Organic Light Emitting Diode (AMOLED), or a Flexible LED (FLED), but is not limited thereto. In the present disclosure, the touch screen 1080 may display a reproduction time determining mode, in which a reproduction time of a selected sound source file may be determined, and select a specific region included and displayed in the reproduction time determining mode. Further, the touch screen 1080 may select any one sound source file among a plurality of stored sound source files, and select a reproduction time determining mode in order to determine a reproduction time of a selected sound source file.

The memory 1010 may be combined with the memory interface 1021. The memory 1010 may include one or more high-speed random access memories and/or non-volatile memories, such as a magnetic disk storage device, one or more optical storage devices, and/or a flash memory, e.g., NAND and NOR.

The memory 1010 stores software. A software element includes an operating system module 1011, a communication module 1012, a graphic module 1013, a user interface module 1014, a CODEC module 1015, a camera module 1016, and one or more application modules 1017. Further, the module that is the software element may be expressed by a set of instructions, so that the module may be expressed as an instruction set. The module may also be expressed as a program. The operating system software 1011, e.g., an internal operating system, such as WINDOWS, LINUX, Darwin, RTXC, UNIX, OS X, or VxWorks, includes various software elements controlling a general system operation. The control of the general system operation includes, for example, a memory management and control, a storage hardware (device) control and management, and a power control and management. Such operating system software also performs a function of facilitating communication between various hardware devices and software elements, e.g. modules. In the present disclosure, when a difference in a feature vector value is greater than or equal to a predetermined feature vector value, and the feature vector value is maintained within the predetermined feature vector value range, the memory 1010 registers a part of a sound source file corresponding to a time, at which the feature vector value serving as a reference is extracted, as the estimated highlight section.

The communication module 1012 may enable the electronic apparatus 1000 to communicate with other electronic apparatus, such as a computer, a server, and/or a portable terminal, through the wireless communication sub-systems 1030 and 1031 or the external port 1060.

The graphic module 1013 includes various software elements for providing and displaying graphics on the touch screen 1080. A term “graphics” refers to, inter alia, text, a web page, an icon, a digital image, a video, an animation, and the like.

The user interface module 1014 includes various software elements related to the user interface. The user interface module 1014 contains contents regarding how a state of the user interface is changed, a specific condition, under which a state of the user interface is changed, and the like.

The CODEC module 1015 may include software elements related to encoding and decoding of a video file. The CODEC module may include a video stream module, such as an MPEG module and/or an H204 module. Further, the CODEC module may include various codec modules for an audio file, such as Advanced Audio Coding (AAA), Adaptive Multi-Rate (AMR), and Windows Media Audio (WMA). Further, the CODEC module 1015 includes a set of instructions corresponding to the method of implementing the present disclosure.

The camera module 1016 includes camera-related software elements so as to perform camera-related processes and functions.

The application module 1017 includes an Internet browser, an email function, an instant message function, a word processing function, a keyboard emulation function, an address book function, a touch list function, a widget function, a Digital Right Management (DRM) function, a voice recognition function, a voice copy function, a position determining function, and a location based service.

Further, various functions of an electronic apparatus 1000 according to the present disclosure, which have been described above and will be described below, may be executed by hardware, software, and/or a combination thereof, which include at least one processing and/or Application Specific Integrated Circuit (ASIC).

Accordingly, an electronic apparatus and method are provided for extracting a highlight section of a sound source, when a specific region included and displayed in a reproduction time determining mode is selected, providing for rapid extraction of only a highlight section of the selected sound source file, thereby decreasing interaction of a user and improving convenience for the user.

While the present disclosure has been shown and described with reference to certain embodiments thereof, it will be apparent to those skilled in the art that the camera lens module according to the present disclosure is not limited to these embodiments, and various changes in form and details may be made therein without departing from the spirit and scope of the present disclosure as defined by the appended claims.

1. A method of operating an electronic apparatus, the method comprising:
displaying, by the electronic apparatus, a reproduction time determining mode selection screen, through which a reproduction time of at least one selected sound source file is determined;
selecting a specific region included in the displayed reproduction time determining mode selection screen; and
extracting a highlight section of the at least one selected sound source file in response to the selection of the specific region

2. The method of claim 1, further comprising:
selecting at least one sound source file among one or more sound source files stored in the electronic apparatus; and
selecting a reproduction time determining mode of the at least one selected sound source file through the reproduction time determining mode selection screen, to determine a reproduction time of the at least one selected sound source file.

3. The method of claim 1, further comprising:
continuously reproducing only the highlight section of the at least one extracted sound source file.

4. An electronic apparatus; comprising:
a memory; and
a processor configured to
extract a feature vector value from each divided sound source file, generate a first table and a second table with the extracted feature vector value, extract at least one estimated highlight section from a selected sound source file by using the generated second table, and extract one estimated highlight section among the extracted at least one estimated highlight section as a highlight section.

5. The electronic apparatus of claim 4, wherein the processor is further configured to extract the feature vector value from each divided sound source file using a multi-core solution.

6. The electronic apparatus of claim 4, wherein the extracted feature vector value is a power value of an audio signal and is determined according to:
$$power = 20 log \frac{Σ {x}^{2}}{N} ,$$
wherein x represents an amplitude of a sample value and N represents a number of sample values for a predetermined time.

7. The electronic apparatus of claim 4, wherein in the first table, the extracted feature vector values are classified in a size order.

8. The electronic apparatus of claim 4, wherein, in the second table, the extracted feature vector values are classified in a time order.

9. The electronic apparatus of claim 4, wherein the processor is further configured to compare each extracted feature vector value with a predetermined number of previous feature vector values and determine whether a difference in a feature vector value is greater than or equal to a predetermined feature vector value, compare each extracted feature vector value with a predetermined number of subsequent feature vector values and determine whether the feature vector value is maintained within a predetermined range of the feature vector value, divide the selected sound source file into a predetermined number of sections, determine whether the determination is completed within a divided section of the selected sound source file, and repeat the determination when the determination is not completed within the divided section of the selected sound source file, and
when a difference in a feature vector value is greater than or equal to the predetermined feature vector value, the feature vector value is maintained within the predetermined feature vector value range, and the memory registers a part of a sound source file corresponding to a time, at which the feature vector value serving as a reference is extracted, as the estimated highlight section.

10. The electronic apparatus of claim 4, wherein the processor is further configured to determines whether a number of registered estimated highlight sections is one, and when the number of registered estimated highlight sections is determined to be one, extract the at least one estimated highlight section as the highlight section.

11. The electronic apparatus of claim 9, wherein when the difference in the feature vector value is greater than or equal to the predetermined feature vector value, or the feature vector value is not maintained within the predetermined range of the feature vector value, the processor further determines whether the determination is completed within the divided section of the selected sound source file.

12. The electronic apparatus of claim 9, wherein when a number of registered estimated highlight sections is two or more, the processor extracts a section closest to a reference of a highlight pattern as the highlight section.

13. The electronic apparatus of claim 11, wherein when the processor determines that the determination is completed, the processor determines whether the estimated highlight section is discovered.

14. The electronic apparatus of claim 13, wherein when the estimated highlight section is not discovered, the processor changes a searching section into an entire selected sound source file and repeats the determination.

15. The electronic apparatus of claim 14, wherein when the processor changes a searching method, in which the processor changes the searching section into the entire selected sound source file, and when the processor determines that the estimated highlight section is not discovered, the processor searches for a section belonging to a subordinate feature vector value within the selected sound source file, compares the feature vector value of the searched section with the predetermined number of subsequent feature vector values, and confirms whether a largest difference in the feature vector value is drawn.
